(19) United States
(12) Patent Application Publication
(10) Pub. No.: US 2012/0299396 A1
(43) Pub. Date: Nov. 29, 2012

(54) COVER FOR CONVERTING ELECTROMAGNETIC RADIATION IN ELECTRONIC DEVICES

(76) Inventors: Shaun Michael Baden, Sudio City, CA (US); Wesley L. Negus, Santa Monica, CA (US); Sunny Trinh, Calabasas, CA (US)

(21) Appl. No.: 13/116,326

(22) Filed: May 26, 2011

(51) Int. Cl. H02J 17/00

(52) U.S. Cl. 307/149

(57) ABSTRACT

A method and apparatus for capturing and converting radio frequency (“RF”) radiation emitted from an electronic device are disclosed. In at least certain embodiments, the method includes capturing at least a portion of the RF radiation emitted from an electronic device and converting it into DC current that can be used for a number of different functional purposes. The electrical energy from the DC current can be used to drive an apparatus including a circuit that provides an indication as to when absorption of RF radiation occurs and its relative intensity. One of the advantages of these techniques is that users can be protected from the potential harmful effects of long-term exposure to the RF radiation emitted from electronic devices, particularly wireless phones which are often held in close proximity to a user's body. The indication can provide users with an indication that the circuit is redirecting RF radiation away from their bodies and dissipating it as electrical energy.

### FIELD OF THE INVENTION

At least certain embodiments of the invention relate generally to RF radiation, and particularly to converting RF radiation in electronic devices.

### BACKGROUND

Electromagnetic radiation can include any form of electromagnetic waves at any frequency, including radio waves, microwaves, infrared, visible light, ultra-violet radiation, X-Rays and Gamma Rays. Of particular interest is electromagnetic radiation in the radio frequency (“RF”) range. RF radiation originates from a variety of electronic devices encountered in everyday life such as wireless phones, music players, microwave ovens, computers, PDAs, and so on. Consequently, exposure by a typical person to RF radiation continues to increase with the prevalence of these devices. Nowadays, the use of wireless phones and other RF radiation generating devices has become so pervasive that many users forego traditional hard-line telephones in their homes for the convenience of wireless connectivity and mobility.

The continued and ever-increasing exposure by the population to RF radiation may have detrimental effects to users over time. It is already known that EM radiation in the very high frequency form of ultraviolet or X-rays can cause damage to Deoxyribonucleic Acid (“DNA”) in humans. It has lately been proposed that lower frequency RF radiation may also have an effect on DNA. As our understanding of RF radiation and its possible detrimental effects continues to develop, it is quite possible that a variety of yet unknown effects from exposure to RF radiation may also be uncovered in the future. This damage may likely be exacerbated by continued exposure at close proximity. For example, use of a wireless telephone or Bluetooth device held in proximity to a user's ear may increase RF radiation exposure and may in turn damage sensitive areas to the brain.

As previously observed with video display monitors, the biological effects of RF radiation are ascertainable, particularly when resonance conditions are met. It has been suggested that the focus of studies which have showed no harmful effects, and which have concluded that wireless telephone radiation is safe, depart from the fact that, in real-life, wireless users are exposed to this radiation numerous times during the course of a day and over the course of several years. Most scientific studies have not taken into account the chronic use of cell phones and other wireless devices. As devices and other sources that emit RF radiation become increasingly prevalent in our everyday lives, so too does the likelihood of exposure by users of these devices. Indeed, in current times it may be difficult, if not nearly impossible, for users to avoid this exposure such as through use of a microwave, interaction with a personal computer, listening to a portable music player, or using a hand-held video game, etc.

### SUMMARY

A method and apparatus for capturing and converting radio frequency (“RF”) radiation emitted from electronic devices are disclosed. In at least certain embodiments, the method includes capturing at least a portion of the RF radiation emitted from an electronic device and converting it into electrical energy. This electric energy can be used for a number of different functional purposes such as to drive an indicator showing when the RF radiation emitted from the electronic device is being captured as well as what its relative intensity is. For example, the electrical energy captured from the electronic device can be used to drive a light-emitting diode (“LED”). In other embodiments, the electrical energy can perform additional functionality such as charging a battery of the electronic device.

The apparatus may include a cover for the electronic device. In at least certain embodiments, the cover includes an embedded circuit having an antenna adapted to capture at least a portion of the RF radiation emitted from the device, an RF conversion circuit to receive the captured RF radiation from the RF antenna and to convert it into electrical energy, and an indicator circuit. In this embodiment, the electric energy is used to drive the indicator circuit to provide users with an indication that at least some of the RF radiation emitted from the electronic device is being diverted away from a user's body and converted into electrical energy. The RF antenna can be positioned near the location where a user's body is in contact or close proximity to the electronic device.

### BRIEF DESCRIPTION OF THE DRAWINGS

For a better understanding of at least certain embodiments, reference will be made to the following Detailed Description, which is to be read in conjunction with the accompanying drawings, wherein:

FIG. 1 depicts a number of RF radiation sources according to one illustrative embodiment.

FIG. 2A depicts an apparatus including a cover for converting RF radiation in an electronic device according to one illustrative embodiment.

FIG. 2B depicts an apparatus including a cover for converting RF radiation in an electronic device according to one illustrative embodiment.

FIG. 3A depicts an apparatus including a circuit for converting RF radiation in an electronic device according to one illustrative embodiment.

FIG. 3B depicts example voltage output waveforms according to one illustrative embodiment.

FIG. 4 depicts a process for converting RF radiation in an electronic device according to one illustrative embodiment.

FIG. 5 depicts an apparatus including a circuit for converting RF radiation in an electronic device according to one illustrative embodiment.

FIG. 6 depicts an apparatus including a circuit for converting RF radiation in an electronic device according to one illustrative embodiment.

### DETAILED DESCRIPTION

Throughout the description, for the purposes of explanation, numerous specific details are set forth in order to provide a thorough understanding of the present invention. It will be apparent to one skilled in the art, however, that the embodiments described herein may be practiced without some of these specific details. In other instances, well-known structures and devices are shown in block diagram form to avoid obscuring underlying principles of embodiments of the invention.

A method and apparatus for capturing and converting RF radiation emitted from an electronic device are disclosed. In at least certain embodiments, the method includes capturing at least a portion of the RF radiation emitted from an electronic device and converting it into electric energy such as DC current. The DC current can then be used for a number of different functional purposes. For example, the DC current can be used to drive an indicator circuit to provide an indication when the RF radiation is being captured. The indicator circuit may include an LED that varies its brightness according to the relative power level of the RF radiation being absorbed. The electrical energy captured from the electronic device can be used to drive the LED to visually alert users during times when RF radiation is being captured and to allow users to observe the relative intensity of the captured RF radiation.

This is advantageous for several reasons. First, the LED can give a visual indication to a user showing the user when—and how much—RF radiation is being captured from their particular electronic devices. As the portion of RF radiation emitted from the users' devices increases, the LED can be configured to flash more brightly and faster, indicating in a very palpable manner to users the amount of RF radiation that is being diverted from their device and dissipated in the circuit described herein. This allows users to visualize and hence begin to understand the amount of RF radiation emitted from their devices that they are being exposed to at various times throughout the day, both at times during use and also when idle. This enables users to understand the amount of RF exposure their devices are subjecting them to, and to further understand in a very real sense their long-term exposure to these potentially harmful levels of RF radiation. Second, having provided an indication to users about the amount of RF radiation they are experiencing in their everyday lives, the techniques described herein are also advantageous in giving users the motivation to modify their behavior to avoid or at least moderate their exposure to this radiation.

The techniques described herein are not limited to any particular LED. The LED can be implemented on a flexible or rigid substrate. In addition, the LED can be made of any inorganic or organic materials, and can be of variable brightness. Organic composites or polymers such as light-emitting polymers (“LEPs”) or organic LEDs (“OLEDs”) can be used. The OLEDs and LEPs can be used to create a visual indication that is not limited to a flashing LED. For example, the LED can also be a display screen that lights up during times when the RF radiation is being captured. These display screens can be used to display any number of different displays such as a particular pattern, information such as date and time of day, a banner advertisement, or other display of information; or any other text or pictures. The electrical energy can also be used to drive other types of indicator circuits to provide a palpable indication to users. The indicator circuits can include sound or vibration, or any combination of these indications. The electrical energy captured from the RF radiation can also be used to perform additional functionality in the electronic device such as charging a battery.

In one embodiment, all the electrical power necessary to drive the indicator circuit such as an LED is derived from the captured RF radiation, and in other embodiments, the electrical power may be derived from additional sources such as the electronic device's battery.

The apparatus disclosed herein may include a cover for the electronic device. For the purposes of the present description, the term “cover” is to be interpreted broadly to include a hard or soft cover for the electronic device, a skin, or coating, etc. The cover may also be built into, or otherwise be an integral part of, the electronic device itself; and accordingly can be marketed and sold as a complete package of device and cover together. The cover may also be separate from the skin or outer shell of the electronic device, or can be any combination of these. In one embodiment, the cover can be a protective cover that may be in any form such as a protective case, shielding, article of clothing, a sticker or other adhesive material, or even a clip or clamp that can be secured to an electronic device for the purposes of capturing RF radiation emitted from the electronic device; or any combination of these embodiments. The cover can be fabricated of any material such as an insulating or conductive material, or metallic material, Velcro or related material, or even a single molded piece of material of any composition.

The cover may also include built-in electrical contacts configured to interface with corresponding electrical contacts of an electronic device such that the captured RF radiation can drive the interface of the device. In such an embodiment, the device software, hardware or combination of device software and hardware can be used in combination with the embodiments described herein to provide an indication originating from within the electronic device itself. For example, the contacts on the cover can be aligned with contacts built into the electronic device such as a device interface to provide an indication from the device itself. For example, the indication can be provided on the screen or other indication mechanism of the electronic device alerting users during times when RF radiation is being captured. In addition, the amount of RF radiation over time can be calculated by the device such as through the use of device software, hardware, or combination and can be provided to users from the electronic device such as on the screen or other output mechanism of the device. The contacts of the cover can be driven by the electronic current generated by the cover during RF radiation capture.

The apparatus can include a cover having an embedded RF antenna adapted to capture at least a portion of the RF radiation emitted from the device, an RF conversion circuit adapted to receive the captured RF radiation from the RF antenna and to convert it into DC current, and an indicator circuit to provide an indication to users during times when RF radiation is being captured. The indicator circuit can also provide an indication of the relative intensity of the RF radiation being absorbed by the described embodiments. The RF antenna can be positioned at a location near where a user's body would come into contact or proximity to the electronic device. By capturing a portion of the RF radiation emitted from the electronic device, users can be protected from that portion of RF radiation which would otherwise be channeled into their bodies.

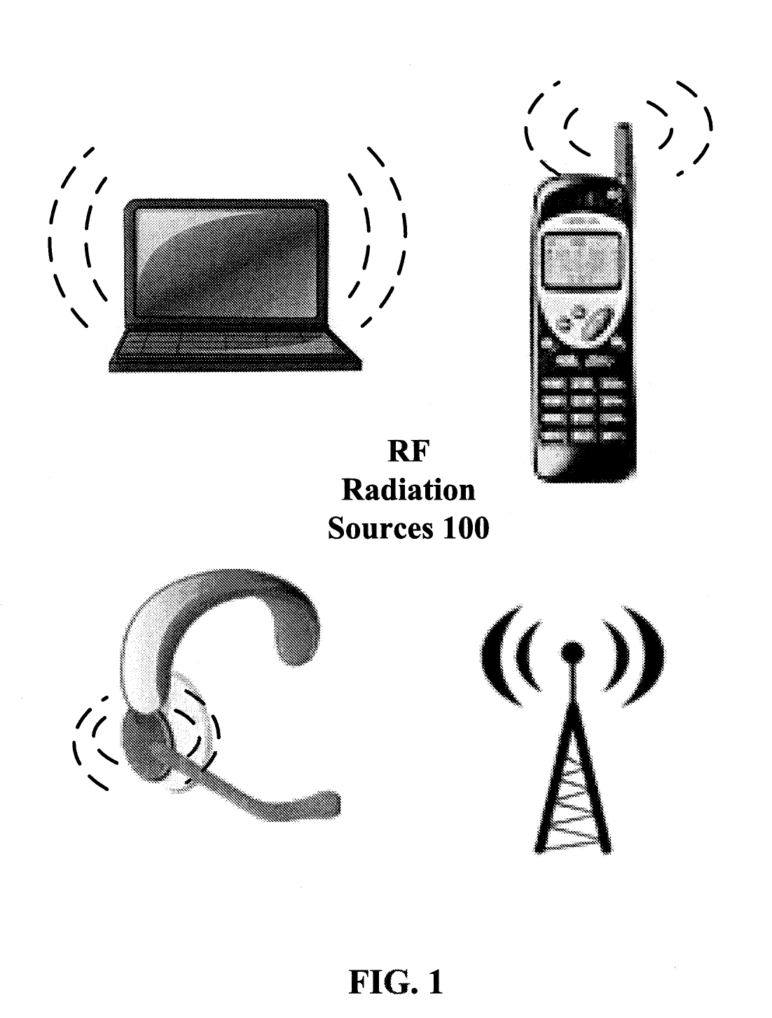

FIG. 1 depicts a number of RF radiation sources 100 according to one illustrative embodiment. There are many sources of RF radiation that people are exposed to in their everyday lives including wireless phones and headsets, computers, televisions, wireless routers and gateways, cable modems, microwaves, hair dryers, etc. One of the advantages of the techniques described herein is that users can be protected from the potential harmful effects of long-term exposure to the RF radiation emitted from electronic devices, particularly wireless phones and headsets, which are often held in close proximity to a user's body. A portion of the RF radiation emitted from users' electronic devices can be diverted and dissipated in the indicator circuit of the apparatus described herein. As such, these techniques can be used to avoid or mitigate the long-term effects of RF radiation exposure by allowing users to place a cover on his or her electronic devices that functions to convert some of the RF radiation into electrical energy. This electrical energy can be used to drive an indicator or to perform other useful work for users, or both. For example, the redirected electrical energy can be also used to drive various electronic functionality of the electronic device such as charging its battery.

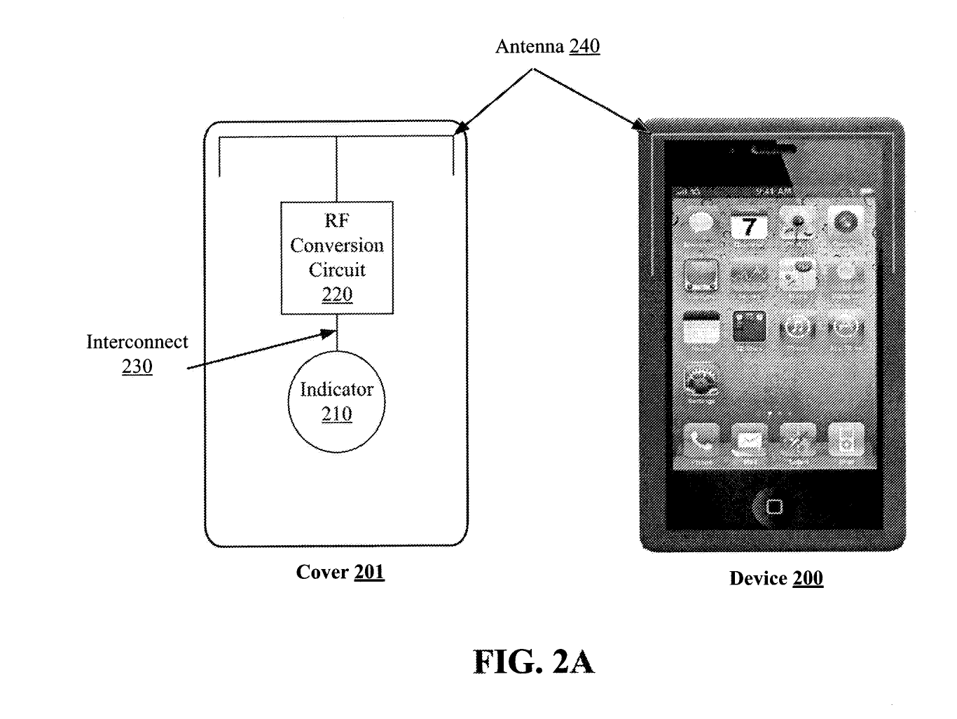

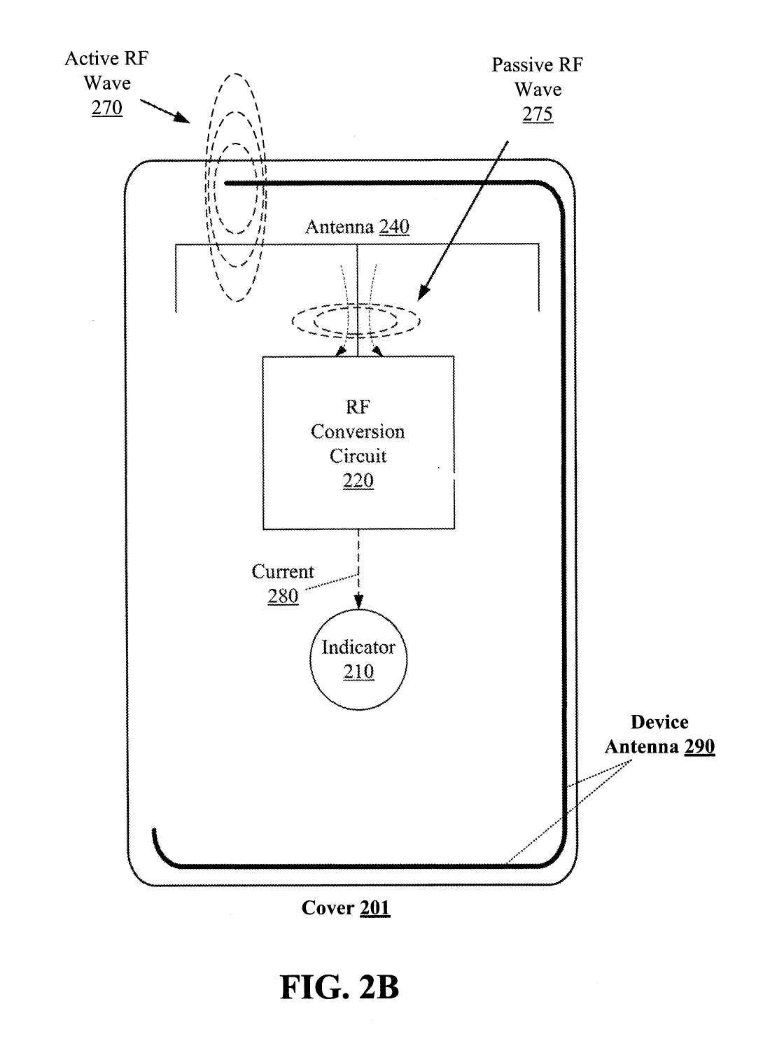

FIG. 2A depicts an apparatus including a cover for converting RF radiation in an electronic device according to one embodiment. In the illustrated embodiment, cover 201 is used to convert RF radiation emitted from electronic device 200. Cover 201 includes an RF antenna 240 coupled with an RF conversion circuit 220. The RF conversion circuit 220 is further coupled with an indicator circuit 210 via an interconnect 230. Antenna 240 is adapted to capture at least a portion of the RF radiation emitted from the electronic device 200. The RF radiation captured by antenna 240 is then output to RF conversion circuit 220 where it is converted into DC electric current supplied to indicator circuit 210. As described above, indicator circuit 210 can include any visual, auditory, or other palpable indicator to alert users during times when the RF radiation emitted from their electronic device 200 is being captured and converted into electrical energy. Antenna 240 may be either a passive antenna, or a partially passive and partially active antenna. But a passive antenna is preferred as it avoids interference with the electronic device. Antenna 240 may be a dipole antenna, a meandering antenna, a monopole antenna, or any other directional or omni-directional antenna that can capture RF radiation.

In addition, antenna 240 may include multiple antennas such as would be used in an embodiment where it is desirable to capture multiple frequencies of RF radiation from an electronic device for versatility or compatibility purposes. The multiple antenna embodiment may be useful for capturing different frequencies known to be used by different manufacturers, or the same manufacturer. Table 1 lists a number of frequencies used by various current manufacturers of wireless telephones:

| Carrier | Frequencies | | Technology |
|---|---|---|---|
| AT&T | 850 | MHz | GSM/GPRS |
| | 1900 | MHz | EDGE |
| | 1.7/2.1 | GHz | UMTS/HSPA |
| | | | LTE |
| Metro PCS | 1900 | MHz | CDMA 2000 1X Ev-Do |
| | 1.7/2.1 | GHz | LTE |
| Nextel | See Sprint | | iDEN |
| Qualcomm | 700 | MHz | MediaFLO |
| Sprint | 1900 | MHz | CDMA 2000 1X Ev-Do |
| | | | CDMA |
| T-Mobile | 1900 | MHz | GSM/GPRS |
| | 1.7/2.1 | GHz | EDGE |
| | | | UMTS |
| | | | LTE |
| Verizon | 850 | MHz | CDMA |
| | 1900 | MHz | CDMA 2000 1X Ev-Do |
| | 700 | MHz | LTE |

The operation of the preferred embodiment of the apparatus will now be described with reference to FIG. 2B. In the illustrated embodiment, the antenna 290 of device 200 is shown superimposed on top of cover 201. During operation of the electronic device, antenna 290 emits an active RF waveform 270. This can be during a phone call, for example, or at another active period of the electronic device, although enough RF radiation may be emitted even during passive periods of the electronic device. When the active RF wave 270 is generated by device antenna 290, part of the wave is captured by antenna 240 of the cover 201 through electromagnetic induction. This captured part of the active RF wave is shown as passive RF wave 275 in the diagram. As described above, antenna 240 need not be limited to a passive antenna, but in the preferred embodiment, a passive antenna is used both for better cost efficiency and also so that it does not interfere with the active device antenna 290 of the device. Also as discussed above, antenna 240 can be a single or multiple antennas. In this embodiment, once passive RF wave 275 is captured by antenna 240, it is driven through to RF conversion circuit 220 where it gets converted to an electric current 280, and then driven out to indicator circuit 210.

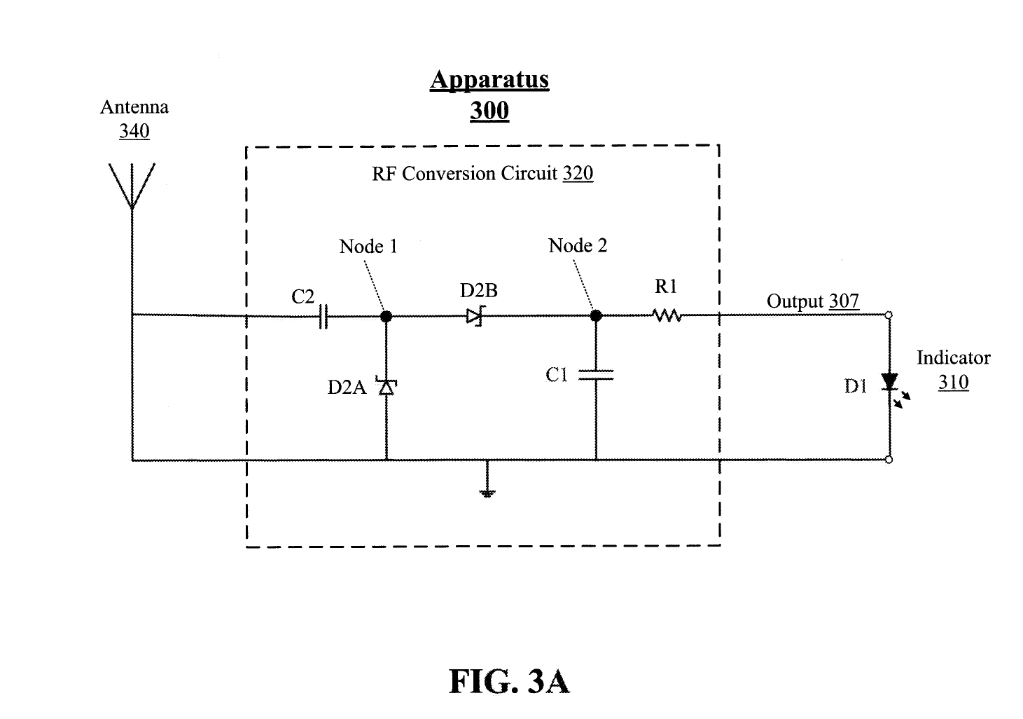

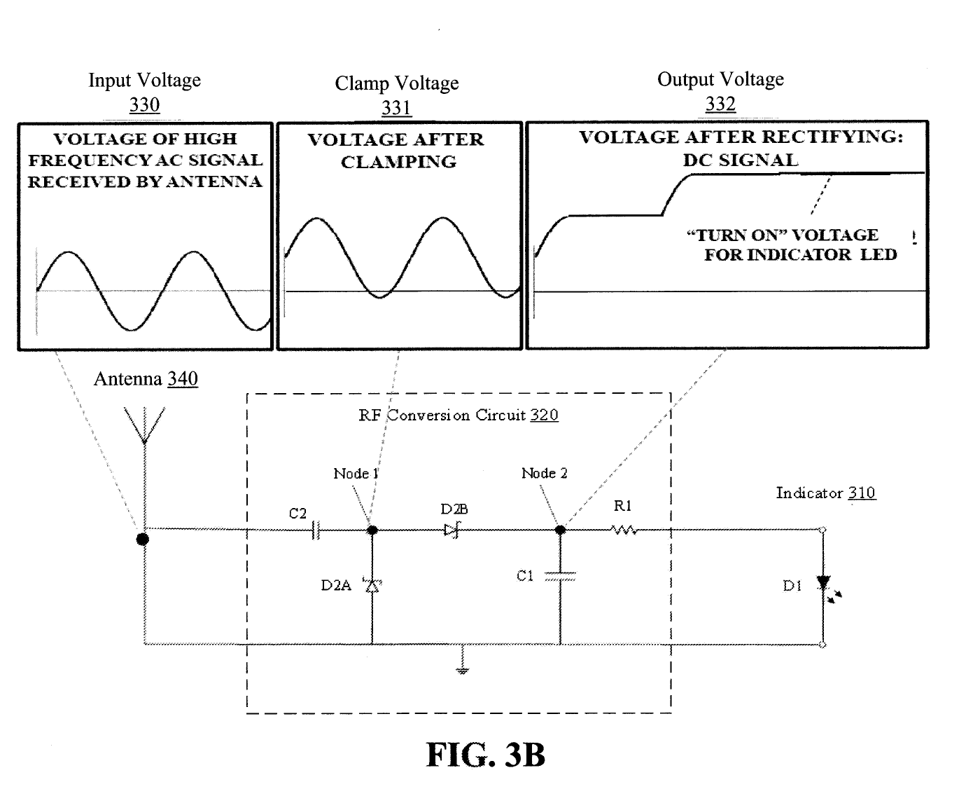

FIG. 3A depicts an example embodiment of an apparatus including a circuit for converting RF radiation in an electronic device. Apparatus 300 includes antenna 340, RF conversion circuit 320, and an indicator circuit 310. The antenna can be any antenna that captures RF radiation. In the illustrated embodiment, RF conversion circuit 320 includes a clamp circuit followed by a rectifier circuit. The clamp circuit includes diode D2A in parallel with capacitor C2. The output of the clamp circuit is Node 1. The rectifier circuit includes diode D2B and capacitor C1. The output of the rectifier circuit is Node 2. Resistor R1 is optional and can be configured by the circuit designer to adjust the flow of current at the output 307 from RF conversion circuit 320 to the indicator circuit 310. In the illustrated diagram, indicator 310 includes a LED D1.

The operation of the apparatus 300 will now be described with reference to FIG. 3B, which depicts example voltage output waveforms output according to one illustrative embodiment. As shown in the illustration, the input voltage 330 of the RF radiation received by antenna 340 is a normal sinusoidal wave signal that oscillates equally above and below zero volts (i.e., ground potential). The voltage waveform 331 at the output of the clamping circuit (Node 1) is also a sinusoidal wave signal, but it has been shifted up by some positive value according to the voltage present across capacitor C2 and limited to the difference between ground and the forward bias voltage of the diode. The voltage waveform 332 after the rectifier circuit (Node 2) approximates a DC signal held in a steady-state by capacitor C1 as shown in the diagram. According to this embodiment therefore an input sinusoidal signal associated with the RF radiation received at antenna 340 is converted to an output DC signal at Node 2 that is used to drive current through R1 into the indicator circuit 310.

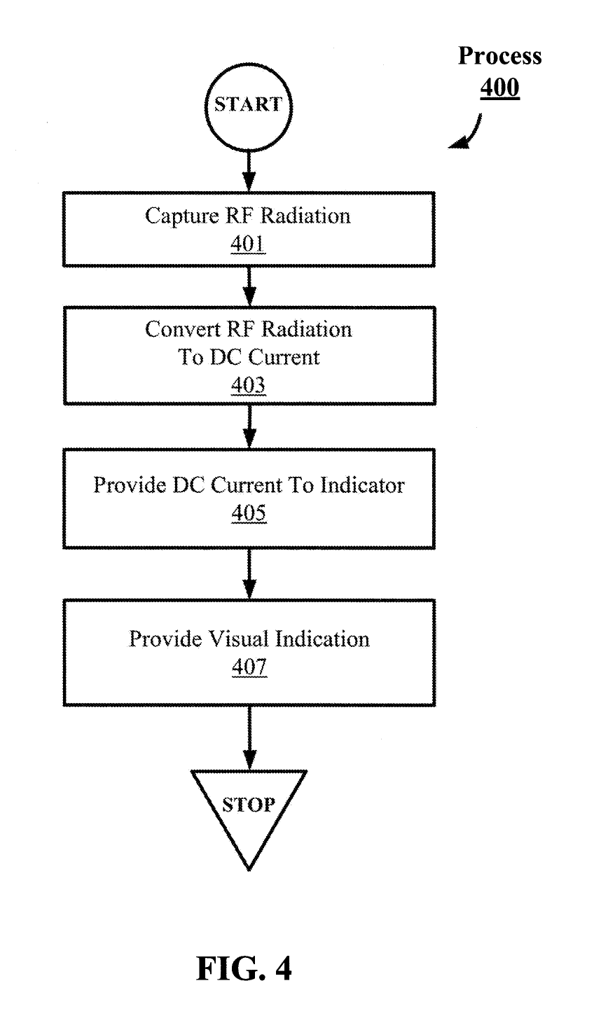

FIG. 4 depicts a process for converting RF radiation in an electronic device according to one illustrative embodiment. Process 400 begins by capturing at least a portion of the RF radiation emitted from a particular electronic device (operation 401). As described above, this is done using an antenna or other equivalent mechanism to divert part of the RF radiation to an antenna through electromagnetic induction. The captured RF radiation is then converted to DC current (operation 403) and provided to an indicator circuit (operation 405). The indicator circuit provides the visual indication at operation 407. In one embodiment, the visual indication provides both an indication as to when the absorption of RF radiation occurs and its relative intensity. This completes process 400 according to one embodiment. As discussed above, embodiments may include other types of indications and are not limited to visual indications.

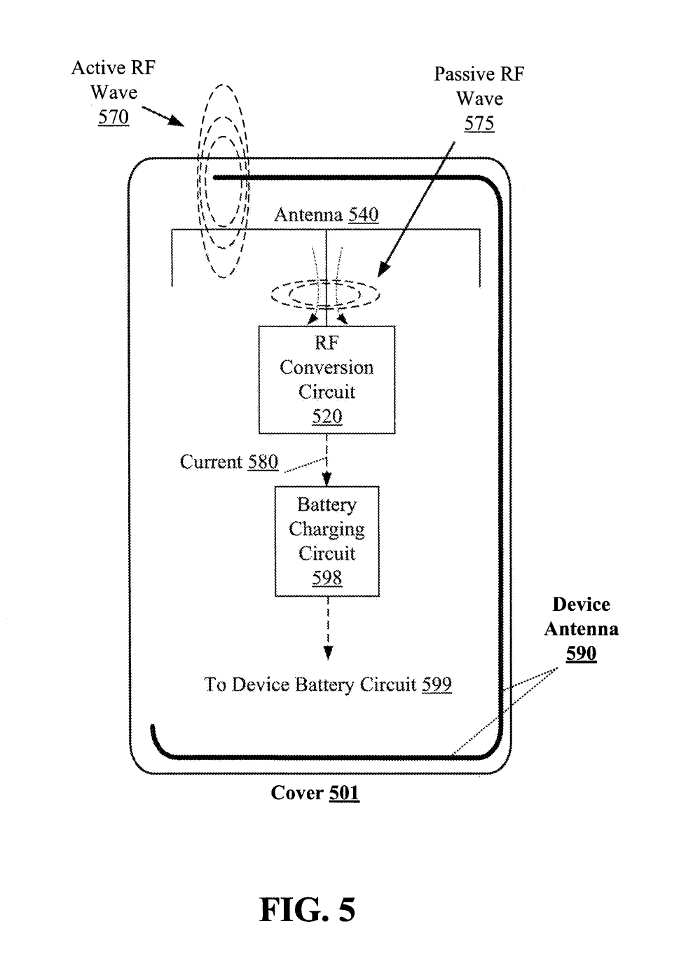

The electric energy generated from the captured RF radiation can also be used to provide useful work. For example, the DC current can be used to charge a battery of the electronic device as shown in FIG. 5, which depicts an example apparatus including a circuit for converting RF radiation in an electronic device. In the illustrated embodiment, current 580 that is driven from the output of RF conversion circuit 520 is used to drive a battery charging circuit 598 that is output to a device battery circuit 599 of the electronic device (not shown) to charge the battery of the electronic device. Therefore the captured RF radiation 575 can be used to charge the battery of the electronic device. This can be accomplished by itself as shown in FIG. 5, or in combination with driving the LED.

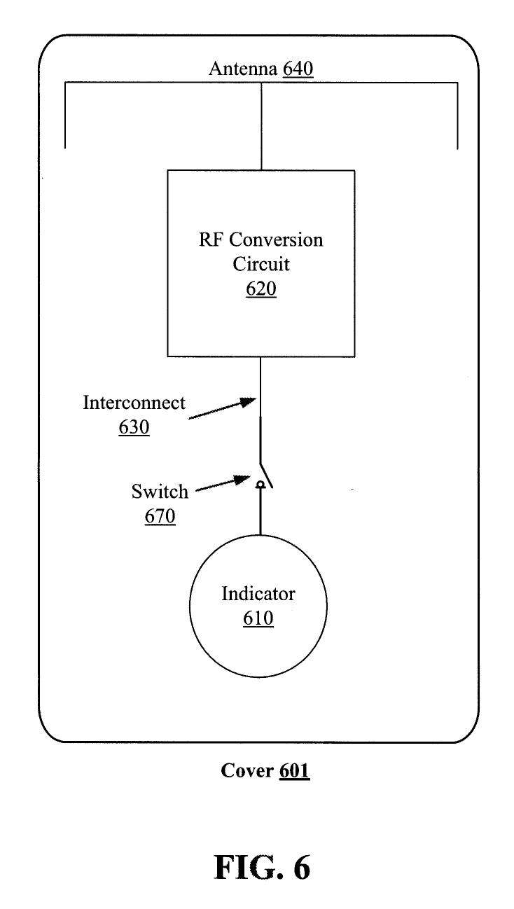

In addition, a switch can be used to allow users to turn off the indication circuit during times when it is undesired, such as during a theater performance. FIG. 6 depicts an example apparatus including a cover having a switch 670 that is adapted to selectively activate and deactivate the indicator 610, although other embodiments are possible. In this embodiment, the switch 670 is located on the interconnect 630 between RF conversion circuit 620 and indicator circuit 610. When the switch 670 is placed in the open position as shown in the diagram, interconnect 630 becomes an open circuit and no current flows through to drive the indicator 610. When this happens, the indicator 610 will be shut off. And during times when the switch 670 is placed in the closed position (not shown), interconnect 630 becomes a closed circuit, and current can flow through to drive the indicator 610. When this happens, the indicator 610 will be turned on. This functionality provides users with a selection mechanism to turn on and off the indicator 610 as desired. Such a switch 670 can be actuated by any user input device in the field of art. This switch 670 can also be configured to interface with the electronic device such that it is actuated whenever a user switches their electronic device to silent mode, for example.

Various techniques described herein may also be used in combination with other RF radiation abatement techniques. For example, RF radiation absorption materials such as paramagnetic materials or other RF absorption materials or fabrics may be used to further limit users' exposure to RF radiation emitted from their electronic devices. Throughout the foregoing description, and for the purposes of explanation, numerous specific details are set forth in order to provide a thorough understanding of the described techniques. It will be apparent, however, to one skilled in the art that these techniques may be practiced without some of these specific details. Although various embodiments which incorporate these teachings have been shown and described in detail, those skilled in the art could readily devise many other varied embodiments or mechanisms to incorporate these techniques.

Also, embodiments may include various operations as set forth above, fewer operations, or more operations; or operations in an order. Accordingly, the scope and spirit of the invention should be judged in terms of the claims which follow as well as the legal equivalents thereof.

What is claimed is:

1. A method comprising:
capturing radio frequency (“RF”) radiation emitted from an electronic device using an antenna;
converting the RF radiation into DC current;
outputting the DC current to an indicator circuit; and
providing an indication during times when RF radiation emitted from the electronic device is being captured.

2. The method of claim 1, wherein the antenna is adapted to be positioned proximate to a location where a user interacts with the electronic device.

3. The method of claim 1, further comprising protecting the user from a portion of the RF radiation emitted from the electronic device by converting it into electrical energy.

4. The method of claim 1, wherein the antenna is a passive antenna configured to couple with the RF radiation emitted by the electronic device through electromagnetic induction to divert at least a portion of the RF radiation into electrical energy.

5. The method of claim 1, wherein the indication includes a visual indication showing when absorption of RF radiation occurs and its relative intensity.

6. The method of claim 5, wherein the visual indication includes activating a light-emitting diode (“LED”).

7. The method of claim 6, wherein the visual indication is displayed from the electronic device itself.

8. The method of claim 1, further comprising reducing at least some of the harmful effects of RF radiation from long-term exposure.

9. The method of claim 1, further comprising providing additional functionality to the electronic device using the DC current.

10. The method of claim 9, wherein the additional functionality includes charging a battery of the electronic device.

11. A cover for an electronic device comprising:
an RF antenna embedded into the cover, the RF antenna configured to capture at least a portion of radio frequency (“RF”) radiation emitted from the electronic device;
an RF conversion circuit electrically coupled with the RF antenna, the conversion circuit configured to receive the captured RF radiation from the RF antenna and to convert it into DC current; and
an indicator circuit configured to receive the DC current output from the RF conversion circuit and to provide an indication during times when RF radiation emitted from the electronic device is being captured.

12. The cover of claim 11, wherein the antenna is positioned proximate to a location where a user interacts with the electronic device.

13. The cover of claim 11, wherein the cover is adapted to protect users from a portion of the RF radiation emitted from the electronic device by converting it into electrical energy.

14. The cover of claim 11, wherein the antenna is a passive antenna configured to couple with the RF radiation emitted from the electronic device through electromagnetic induction to divert at least a portion of the RF radiation into electrical energy.

15. The cover of claim 11, wherein the user is protected from that portion of the RF radiation emitted from the electronic device that is dissipated in the indicator circuit.

16. The cover of claim 11, wherein the indicator circuit includes a light-emitting diode (“LED”) to provide the visual indication showing when absorption of RF radiation occurs and its relative intensity.

17. The cover of claim 16, wherein the visual indication is displayed from the electronic device itself.

18. The cover of claim 11, wherein the protection provided by the cover is adapted to reduce at least some of the harmful effects of RF radiation from long-term exposure.

19. The cover of claim 11, wherein the RF conversion circuit comprises a clamp circuit followed by a rectifier circuit.

20. The cover of claim 19, wherein the RF conversion circuit includes multiple stages of a clamp circuit followed by a rectifier circuit.

21. The cover of claim 11, wherein the DC current provides additional functionality to the electronic device.

22. The cover of claim 21, wherein the additional functionality includes charging a battery of the electronic device.

23. The cover of claim 11, wherein all power necessary to drive the indicator circuit comes from the captured RF radiation.

24. The cover of claim 11, wherein the cover is either part of the electronic device or is a separate apparatus adapted to be fitted or attached to the electronic device.

25. A case for an electronic device comprising:
an RF antenna built into the case, the RF antenna configured to capture a portion of radio frequency (“RF”) radiation emitted from the electronic device;
an RF conversion circuit configured to receive the captured RF radiation from the RF antenna and to convert it into DC current; and
an indicator circuit electrically coupled with the RF conversion circuit, wherein indicator circuit is configured to provide an indication showing when absorption of RF radiation occurs and its relative intensity.

26. The case of claim 25, wherein the RF antenna is positioned proximate to a location where a user interacts with the electronic device.

27. The case of claim 25, wherein the case is configured to protect users from a portion of the RF radiation emitted from the electronic device by converting it into electrical energy.

28. The case of claim 25, wherein all power necessary to drive the indicator circuit comes from the captured RF radiation.

29. The case of claim 25, wherein the case is either part of the electronic device or is a separate apparatus adapted to be fitted or attached to the electronic device.

30. A circuit comprising:
an RF antenna configured to capture a portion of radio frequency (“RF”) radiation emitted from an electronic device;
an RF conversion circuit configured to receive the captured RF radiation and to convert it into DC current;
an interconnect coupled between the RF conversion circuit and an indicator circuit,
wherein the indicator circuit is adapted to receive the DC current output from the RF conversion circuit via the interconnect and to provide a visual indication showing when at least a portion of the RF radiation emitted from the electronic device is being captured and its relative intensity.

31. The circuit of claim 30, wherein the RF antenna is positioned proximate to at least one location where a user interacts with the electronic device.

32. The circuit of claim 30, wherein the RF conversion circuit comprises a clamp circuit followed by a rectifier circuit.

33. The circuit of claim 32, wherein the RF conversion circuit includes multiple stages of a clamp circuit followed by a rectifier circuit.

34. The circuit of claim 30, wherein the circuit is adapted to protect users from the portion RF radiation emitted from the electronic device that is dissipated in the indicator circuit.

35. The circuit of claim 30, wherein all power necessary to drive the indicator circuit comes from the captured RF radiation.
